(19) United States
(12) Patent Application Publication
(10) Pub. No.: US 2014/0158539 A1
(43) Pub. Date: Jun. 12, 2014

(54) ACTIVE REGENERATION METHOD FOR DEIONIZATION MODULE AND WATER TREATMENT APPARATUS USING THE SAME

(71) Applicant: COWAY CO., LTD., Chungcheongnam-do (KR)

(72) Inventors: Kyung-Heon Lee, Seoul (KR); Tae-Yong Son, Seoul (KR); Hyoung-Min Moon, Seoul (KR); Soo-Young Lee, Seoul (KR); Hee-Do Jung, Seoul (KR); Hyun-Woo Lee, Seoul (KR)

(73) Assignee: COWAY CO., LTD., Chungcheongnam-do (KR)

(21) Appl. No.: 14/119,129

(22) PCT Filed: Apr. 18, 2012
(86) PCT No.: PCT/KR2012/002957

§ 371 Date: Nov. 20, 2013

(30) Foreign Application Priority Data
May 26, 2011 (KR) 10-2011-0050088

(51) Int. Cl. C02F 1/46; C02F 1/469

(52) U.S. Cl. CPC C02F 1/4602; C02F 1/4604; C02F 1/4691; C02F 1/4693; C02F 1/4695
USPC 204/519; 204/628; 204/661; 204/555

(57) ABSTRACT

There are provided an active regeneration method for a deionization module, and a water treatment apparatus using the same. The water treatment apparatus may include: a power applying unit applying power to the deionization module in order to perform a regeneration process a regeneration parameter measuring unit measuring a regeneration parameter of the deionization module when the power is applied; and a controlling unit terminating the regeneration process, based on the measured regeneration parameter.

### TECHNICAL FIELD

The present invention relates to a water treatment apparatus.

### BACKGROUND ART

As environmental pollution, in particular, water pollution, has recently come to prominence as a social issue, water treatment apparatuses physically or chemically filtering water and removing impurities therefrom have increasingly been used. Water treatment apparatuses may be classified as a natural filtering type, a forced filtering type, an ion exchange resin type, a reverse osmotic type, and the like, in accordance with methods for purifying water. Among these types, the ion exchange resin type water treatment apparatus adopts a scheme of allowing various ions or the like contained in water to be adhered to an ion exchange resin to supply purified water from which the ions or the like have been removed.

However, water purifying capability may be degraded as the amount of ions adhered to the ion exchange resin increases. Thus, a regeneration process for removing the adhered ions or the like and restoring the ion exchange resin to an original state thereof may be required. That is, an ion exchange resin may be restored to an original state thereof through a regeneration process in which an operation of removing ions or the like from an ion exchange resin by applying a constant level of voltage thereto and an operation of discharging water containing ions or the like to the outside are repeated predetermined times.

However, according to the regeneration process in the related art, a time at which r generation operation has been completed may not be accurately confirmed because the quality of water, that is, the amount of ions therein, has not been considered. Thus, unnecessary power usage may be caused due to repetitive voltage application. In addition, since the regeneration process may be repetitively undertaken predetermined times, it may take an unnecessarily long time and require an extremely large amount of wasted water.

### DISCLOSURE OF INVENTION

### Technical Problem

An aspect of the present invention provides an active regeneration method for a deionization module, capable of reducing unnecessary power waste during a regeneration process and decreasing a time required for, and an amount of water used in, the regeneration process, and a water treatment apparatus using the same.

### Solution to Problem

According to an aspect of the present invention, there is provided a water treatment apparatus for a deionization module, the apparatus including: a power applying unit applying power to the deionization module in order to perform a regeneration process; a regeneration parameter measuring unit measuring a regeneration parameter of the deionization module when the power is applied; and a controlling unit terminating the regeneration process, based on the measured regeneration parameter.

The applied power may be voltage or current, and the regeneration parameter may be a current value flowing through the deionization module when the applied power is voltage, while the regeneration parameter may be a voltage value of the deionization module when the applied power is current.

The water treatment apparatus may further include an inlet into which water is drawn; and a flow sensor installed at the inlet and measuring an amount of the drawn water.

The controlling unit may allow the power to be applied at a predetermined interval or allow the power to be applied when an accumulated amount of water, measured by the flow sensor, is determined to be greater than a certain amount.

The controlling unit may terminate the regeneration process when the regeneration parameter measured by the regeneration parameter measuring unit is greater than or less than a predetermined reference value.

The controlling unit may terminate the regeneration process when the regeneration parameter measured by the regeneration parameter measuring unit is greater than or less than a certain ratio value with respect to a regeneration parameter measured at a time at which the power is applied.

The deionization module may be a module applied to electrodialysis (ED), electrodeionization (EDI), capacitive deionization (CDI), or a bipolar membrane.

According to another aspect of the present invention, there is provided an active regeneration method for a deionization module, the method including: applying power to the deionization module by a power applying unit in order to perform a regeneration process; measuring a regeneration parameter of the deionization module by a regeneration parameter measuring unit when the power is applied; and terminating the regeneration process by a controlling unit, based on the measured regeneration parameter.

The applied power may be voltage or current, and the regeneration parameter may be a current value flowing through the deionization module when the applied power is voltage, while the regeneration parameter may be a voltage value of the deionization module when the applied power is current.

The active regeneration method may further include measuring an amount of water drawn into the deionization module by a flow sensor.

In the applying of power, the power may be applied by the power applying unit at a predetermined interval or the power may be applied by the power applying unit when an accumulated amount of water measured by the flow sensor is determined to be greater than a certain amount.

In the terminating of the regeneration process, the regeneration process may be terminated by the controlling unit when the regeneration parameter measured by the regeneration parameter measuring unit is greater than or less than a predetermined reference value.

In the terminating of the regeneration process, the regeneration process may be terminated by the controlling unit when the regeneration parameter measured by the regeneration parameter measuring unit is greater than or less than a certain ratio value with respect to a regeneration parameter measured at a time at which the power is applied.

The deionization module may be a module applied to electrodialysis (ED), electrodeionization (EDI), capacitive deionization (CDI), or a bipolar membrane.

### Advantageous Effects of Invention

according to embodiments of the invention, the regeneration parameter of the deionization module is measured while the regeneration process is undertaken, and the regeneration process is terminated based on the measured regeneration parameter, such that unnecessary power usage can be reduced, and time required for and the amount of water used in the regeneration process can be decreased.

### BRIEF DESCRIPTION OF DRAWINGS

FIG. 1 is a configuration view of a water treatment apparatus including a deionization module according to an embodiment of the present invention

FIG. 2 is a configuration view showing an interior of a deionization module according to an embodiment of the present invention and

FIG. 3 is a flow chart showing an active regeneration method for a deionization module according to an embodiment of the present invention.

### BEST MODE FOR CARRYING OUT THE INVENTION

This application claims the priority of Korean Patent Application No. 10-2011-0050088 filed on May 26, 2011, in the Korean Intellectual Property Office, the disclosure of which is incorporated herein by reference.

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and sizes of components are exaggerated for clarity. While those skilled in the art could readily devise many other varied embodiments that incorporate the teachings of the present invention through the addition, modification or deletion of elements, such embodiments may fall within the scope of the present invention.

The same or equivalent elements are referred to by the same reference numerals throughout the specification.

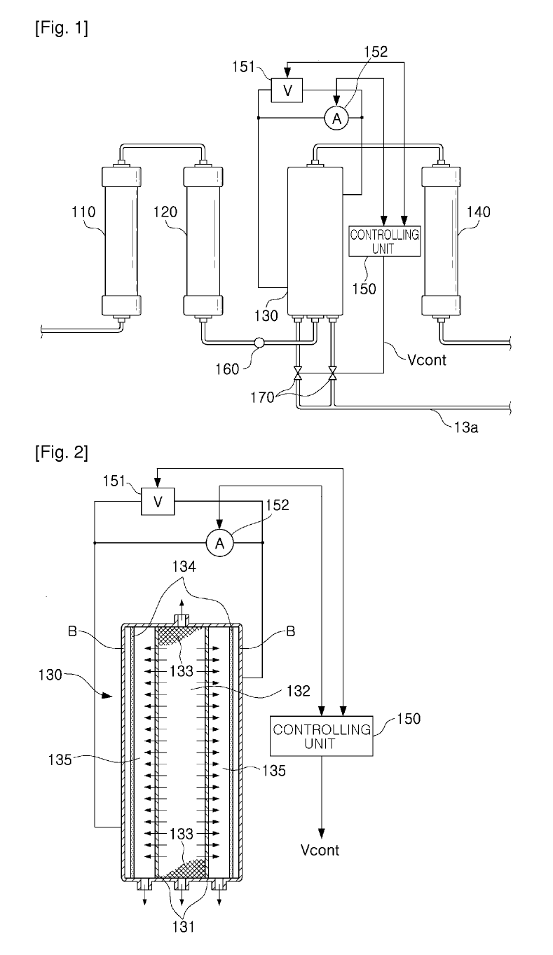

FIG. 1 is a configuration view of a water treatment apparatus including a deionization module 130 according to an embodiment of the present invention.

Referring to FIG. 1, a water treatment apparatus according to an embodiment of the present invention may include a sediment filter 110 removing various contaminants (suspended materials) in the form of large particles, which are present in water, a carbon pre-filter 120 removing chlorine elements and organic chemical substances present in water, a deionization module 130 removing ionic substances such as heavy metals, and the like present in water, and a carbon post-filter 140 removing trace impurities present in water to filter finally cleaned water. Configurations and operations of the sediment filter 110, the carbon pre-filter 120, and the carbon post-filter 140 are identical to those commonly known in the art, and accordingly, a detailed description thereof will be omitted herein.

Meanwhile, the water treatment apparatus according to the embodiment of the present invention may include a voltage applying unit 151 applying voltage to the deionization module 130 to perform a regeneration process, a current measuring unit 152 measuring a current value (a regeneration parameter) flowing through the deionization module 130 when voltage is applied by the voltage applying unit 151, and a controlling unit 150 initiating the regeneration process and terminating the regeneration process, based on the measured current value.

In particular, the controlling unit 150 may initiate the regeneration process at a predetermined interval or may initiate the regeneration process when an accumulated amount of water, measured by a flow sensor 160, to be described later, is determined to be greater than a predetermined amount. In this case, the controlling unit 150 may control the voltage applying unit 151 to apply voltage to the deionization module 130 in order to perform the regeneration process.

In addition, when the regeneration process is initiated, the controlling unit 150 may use the current value flowing through the deionization module 130 due to the voltage applied by the voltage applying unit 151, in order to terminate the regeneration process. In other words, the controlling unit 150 may terminate the regeneration process when the current value flowing through the deionization module 130 is greater than or less than a predetermined reference value, or is greater than or less than a certain ratio value with respect to a current value measured at the time at which the regeneration process is initiated (at a time at which voltage of a certain magnitude is applied).

In addition, when the regeneration process is terminated, the controlling unit 150 may transfer a control signal Vcont to a discharge valve 170 so as to open the discharge valve 170 and the discharge valve 170 may be opened according to the control signal Vcont, such that removed ions may be discharged to the outside through a drainpipe 13a.

The embodiment of the present invention illustrates that voltage is applied by the voltage applying unit 151 and the regeneration process is terminated by using the current value flowing through the deionization module 130 due to the applied voltage; however, the present invention is not necessarily limited thereto.

Specifically, according to another embodiment of the present invention, the voltage applying unit 151 may be substituted with a current applying unit for applying current, and this case, the current measuring unit 152 may be substituted with a voltage measuring unit for measuring a voltage value of the deionization module 130. Thus, in such a case, the controlling unit 150 may terminate the regeneration process when the voltage value (a regeneration parameter) of the deionization module 130 is greater than or less than a predetermined reference value, or is greater than or less than a certain ratio value with respect to a voltage value measured at a time at which the regeneration process is initiated (at a time at which voltage of a certain magnitude is applied).

The embodiment of the present invention describes that the controlling unit 150 terminates the regeneration process based on the voltage value of the deionization module 130 or the current value flowing through the deionization module 130; however, the present invention is not limited thereto. For example, the controlling unit 150 may terminate the regeneration process at a predetermined interval or may terminate the regeneration process when an accumulated amount of water measured by the flow sensor 160, to be described later, is determined to be greater than a certain amount, after the regeneration process has been initiated.

According to the embodiment of the present invention, the water treatment apparatus may further include an inlet of the deionization module 130, through which water pretreated by the carbon pre-filter 120 is supplied, and the flow sensor 160 installed at the inlet and measuring an amount of water drawn into the inlet. Then, the deionization module 130 may be provided with the discharge valve 170 for discharging condensed water containing ions removed from an ion exchange resin to the outside through the drainpipe 13a after the regeneration process has been terminated.

According to the embodiment of the present invention, the discharge valve 170 may be an automatic valve operated according to the control signal Vcont; however, the discharge valve 170 is not limited thereto and it would be obvious for to a person skilled in the art that the discharge valve 170 could be a passive valve that could be manually opened and closed by a user.

Meanwhile, FIG. 2 is a configuration view showing an interior of the deionization module 130 according to an embodiment of the present invention.

Referring to FIGS. 1 and 2, the deionization module 130 may include a body B, a pair of electrodes 134 disposed at both sides of an interior space of the body B, a pair of ion exchange films 131 disposed to be spaced apart at a predetermined interval inwardly of the pair of electrodes 134, and ion exchange resins 133 charged between the pair of ion exchange films 131.

The structure of the deionization module 130 is merely provided by way of example, and the deionization module 130 may be a module applied to electrodialysis (ED), electrodeionization (EDI), capacitive deionization (CDI), or a bipolar membrane. In addition, FIG. 2 merely illustrates a single pair of electrodes 134; however, the electrodes 134 are not limited thereto and may include at least one pair of electrodes.

In a general purification process, water may be drawn into a dilution chamber 132 of the deionization module 130, ions contained in the drawn water may be adhered to the ion exchange resins 133 to be removed from water, and the water from which the ions have been removed may be provided to the carbon post-filter 140.

Meanwhile, when the regeneration process is initiated, voltage of a certain magnitude may be applied to the pair of electrodes 134. Due to the applied voltage, the ions may be removed from the ion exchange resins 133 accumulated in the dilution chamber 132, and the removed ions may be transferred to a condensation chamber 135 through the ion exchange films 131. Thereafter, the removed ions may be discharged to the outside through the discharge valve 170 and the drainpipe 13a.

As described in FIG. 1, current may be applied to the pair of electrodes 134, instead of voltage. Due to the applied current, the ions may be removed from the ion exchange resins 133 accumulated in the dilution chamber 132, and the removed ions may be transferred to the condensation chamber 135 through the ion exchange films 131. Thereafter, the removed ions may be discharged to the outside through the discharge valve 170 and the drainpipe 13a.

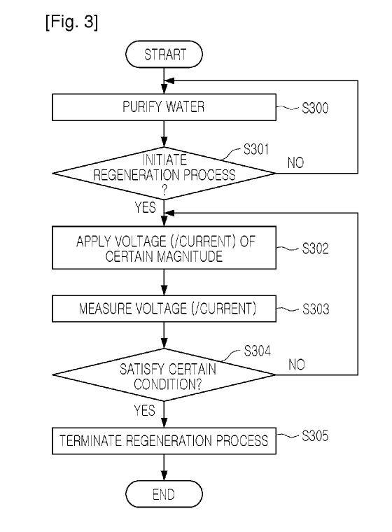

FIG. 3 is a flow chart showing an active regeneration method for a deionization module according to an embodiment of the present invention.

Referring to FIGS. 1 through 3, a process for purifying water (hereinafter, referred to as a ‘water purification process’) is first conducted (S300). Specifically, finally cleaned water may be supplied to the outside through the sediment filter 110 removing various contaminants (suspended materials) in the form of large particles, which are present in water, the carbon pre-filter 120 removing chlorine elements and organic chemical substances present in water, the deionization module 130 removing ionic substances such as heavy metals, and the like present in water, and the carbon post-filter 140 removing trace impurities present in water. As the water purification process is conducted, water may be drawn into the dilution chamber 132 of the deionization module 130, ions contained in the drawn water may be adhered to the ion exchange resins 133 to be removed from water, and the water from which the ions have been removed may be provided to the carbon post-filter 140. The amount of water may be measured in real time by the flow sensor 160 during conducting the process of 5300 and the measured amount of water may be transferred to the controlling unit 150.

Then, the controlling unit 150 may initiate the regeneration process at a predetermined interval or initiate the regeneration process when an accumulated amount of water measured by the flow sensor 160 is determined to be greater than a certain amount (S301).

If the regeneration process is initiated, the controlling unit 150 may transfer a voltage control signal to the voltage applying unit 151 (S302), and the voltage applying unit 151 may apply voltage to the pair of electrodes 134 of the deionization module 130 according to the voltage control signal. Due to the applied voltage, the ions adhered to the ion exchange resins 133 of the deionization module 130 may be removed therefrom, and the removed ions may be transferred to the condensation chamber 135 and arrive at the pair of electrodes 134. For example, positive ions may be led to a negative (−) electrode and negative ions may be led to a positive (+) electrode in accordance with polarities of the pair of electrodes 134. As described above, the electrodes according to the embodiment of the present invention may include at least one pair of electrodes.

Then, the current measuring unit 152 may measure a current value flowing between the pair of electrodes 134 due to the removed ions (S303). The measured current value may be transferred to the controlling unit 150.

Meanwhile, the controlling unit 150 may determine whether the measured current value satisfies certain conditions (S304). That is, the current value measured by the current measuring unit 152 may be determined based on the amount of ions having been removed from the ion exchange resins 133, and current having a high current value may flow at first, according to the applied voltage, the current value thereof may be gradually decreased, and then the current may have a constant current value. Thus, the controlling unit 150 may terminate the regeneration process according to the measured current value.

Specifically, the controlling unit 150 may terminate the regeneration process when the measured current value is greater than or less than a predetermined reference value, or is greater than or less than a certain ratio value with respect to a current value measured at the time at which the regeneration process is initiated (the time at which voltage of a certain magnitude is applied). Meanwhile, although the controlling unit 150 terminates the regeneration process based on the measured current value according to the embodiment of the present invention, it is merely provided by way of example. It would be obvious that the controlling unit 150 may terminate the regeneration process based on a resistance value obtained according to the measured current value and the applied voltage.

Although the embodiment of the present invention illustrates that voltage is applied by the voltage applying unit 151 and the regeneration process is terminated by using the current value flowing through the deionization module 130 due to the applied voltage, the present invention is not necessarily limited thereto.

Specifically, according to another embodiment of the present invention, the voltage applying unit 151 may be substituted with a current applying unit for applying current, and this case, the current measuring unit 152 may be substituted with a voltage measuring unit. Thus, in such a case, the controlling unit 150 may terminate the regeneration process when the voltage value (referred to a ‘regeneration parameter’) of the deionization module 130 is greater than or less than a predetermined reference value, or is greater than or less than a certain ratio value with respect to a voltage value measured at the time at which the regeneration process is initiated (the time at which voltage of a certain magnitude is applied). In addition, the controlling unit 150 may transfer the control signal Vcont to the discharge valve 170 so as to open the discharge valve 170 and the discharge valve 170 may be opened according to the control signal Vcont, such that removed ions may be discharged to the outside through the drainpipe 13a.

According to another embodiment, the controlling unit 150 may terminate the regeneration process at a predetermined interval or terminate the regeneration process when an accumulated amount of water measured by the flow sensor 160 is determined to be greater than a certain amount, after the regeneration process has been initiated.

Finally, when the above-described conditions (in S304) are satisfied, the controlling unit 150 may terminate the regeneration process (S305). However, when the conditions (in S304) are not satisfied, the controlling unit 150 may repeat operations S302 to S304.

As set forth above, according to embodiments of the invention, the regeneration parameter of the deionization module is measured while the regeneration process is undertaken, and the regeneration process is terminated based on the measured regeneration parameter, such that unnecessary power usage can be reduced, and time required for and the amount of water used in the regeneration process can be decreased.

While the present invention has been shown and described in connection with the embodiments, it will be apparent to those skilled in the art that modifications and variations can be made without departing from the spirit and scope of the invention as defined by the appended claims.

1. A water treatment apparatus for a deionization module, the apparatus comprising:
a power applying unit applying power to the deionization module in order to perform a regeneration process
a regeneration parameter measuring unit measuring a regeneration parameter of the deionization module when the power is applied and a controlling unit terminating the regeneration process, based on the measured regeneration parameter.

2. The water treatment apparatus of claim 1, wherein the applied power is voltage or current, and the regeneration parameter is a current value flowing through the deionization module when the applied power is voltage, while the regeneration parameter is a voltage value of the deionization module when the applied power is current.

3. The water treatment apparatus of claim 1, further including:
an inlet into which water is drawn; and
a flow sensor installed at the inlet and measuring an amount of the drawn water.

4. The water treatment apparatus of claim 3, wherein the controlling unit allows the power to be applied at a predetermined interval or allows the power to be applied when an accumulated amount of water, measured by the flow sensor, is determined to be greater than a certain amount.

5. The water treatment apparatus of claim 1, wherein the controlling unit terminates the regeneration process when the regeneration parameter measured by the regeneration parameter measuring unit is greater than or less than a predetermined reference value.

6. The water treatment apparatus of claim 2, wherein the controlling unit terminates the regeneration process when the regeneration parameter measured by the regeneration parameter measuring unit is greater than or less than a certain ratio value with respect to a regeneration parameter measured at a time at which the power is applied.

7. The water treatment apparatus of claim 1, wherein the deionization module is a module applied to electrodialysis (ED), electrodeionization (EDI), capacitive deionization (CDI), or a bipolar membrane.

8. An active regeneration method for a deionization module, the method comprising:
applying power to the deionization module by a power applying unit in order to perform a regeneration process
measuring a regeneration parameter of the deionization module by a regeneration parameter measuring unit when the power is applied and terminating the regeneration process by a controlling unit, based on the measured regeneration parameter.

9. The active regeneration method of claim 8, wherein the applied power is voltage or current, and the regeneration parameter is a current value flowing through the deionization module when the applied power is voltage, while the regeneration parameter is a voltage value of the deionization module when the applied power is current.

10. The active regeneration method of claim 8, further including:
measuring an amount of water drawn into the deionization module by a flow sensor.

11. The active regeneration method of claim 10, wherein in the applying of power, the power is applied by the power applying unit at a predetermined interval or the power is applied by the power applying unit when an accumulated amount of water measured by the flow sensor is determined to be greater than a certain amount.

12. The active regeneration method of claim 8, wherein in the terminating of the regeneration process, the regeneration process is terminated by the controlling unit when the regeneration parameter measured by the regeneration parameter measuring unit is greater than or less than a predetermined reference value.

13. The active regeneration method of claim 8, wherein in the terminating of the regeneration process, the regeneration process is terminated by the controlling unit when the regeneration parameter measured by the regeneration parameter measuring unit is greater than or less than a certain ratio value with respect to a regeneration parameter measured at a time at which the power is applied.

14. The active regeneration method of claim 8, wherein the deionization module is a module applied to electrodialysis (ED), electrodeionization (EDI), capacitive deionization (CDI), or a bipolar membrane.
